(19) United States
(12) Patent Application Publication
(10) Pub. No.: US 2023/0230045 A1
(43) Pub. Date: Jul. 20, 2023

(54) ESTABLISH TRACKING OF SCHEDULED MEETINGS OF ONE PERSON BY ANOTHER PERSON AND RELATED REAL-TIME UPDATING

(71) Applicant: Telefonaktiebolaget LM Ericsson (publ), Stockholm (SE)

(72) Inventors: Gunilla BERNDTSSON, NACKA (SE); Xiaoping LI, Karlskrona (SE); Jonas LUNDBERG, Lulea (SE)

(21) Appl. No.: 17/580,005

(22) Filed: Jan. 20, 2022

(51) Int. Cl. G06Q 10/10; G06F 3/0482; H04L 67/50; H04L 67/54

(52) U.S. Cl. CPC G06Q 10/1095; G06F 3/0482; H04L 67/22; H04L 67/24

(57) ABSTRACT

A meeting server includes at least one processor and at least one memory storing program code performing operations that include to establish tracking of a tracked person's scheduled meetings by a follower person. The meeting server also operates to generate a notification to a device of the follower person based on the tracked person adding a scheduled meeting to a schedule of scheduled meetings maintained by a meeting scheduling program.

### TECHNICAL FIELD

The present disclosure relates to scheduling programs and related meeting servers which schedule meetings and manage meeting schedules.

### BACKGROUND

Conferencing technology has matured and is now easy to access which enables distributed teams to collaborate effortlessly. This has facilitated communication as workplaces have shifting to having employees work remotely from home. The reduced occurrence of informal face-to-face meetings by working remotely has substantially increased the occurrence of more formally scheduled meetings. In one global survey the use of remote video conference has increased by almost 15 times since occurrence of the Covid-19 pandemic. Many people have busy schedules and can receive numerous meeting invitations.

Which of the meeting invitations a person may want to accept may depend upon who else is joining the meeting. The list of participants who have registered to join a meeting, such as a conference or standardization meeting, may be published before the scheduled meeting time. However, the person may also like to know whether a particular person is presently in a scheduled meeting. In order to make that determination, the person would need to first join the scheduled meeting to determine whether the particular person is among a list of present participants. However, further complicating that determination is that the person would need to have been granted permission to join the scheduled meeting, where the permission is usually conditionally granted by the meeting organizer or by satisfying a defined participation rule.

### SUMMARY

Some embodiments disclosed herein are directed to a meeting server which operates to establish tracking of a tracked person's scheduled meetings by a follower person. The meeting server also operates to generate a notification to a device of the follower person based on the tracked person adding a scheduled meeting to a schedule of scheduled meetings maintained by a meeting scheduling program.

Some other corresponding embodiments are directed to a method by a meeting server. The method includes establishing tracking of a tracked person's scheduled meetings by a follower person. The method also includes generating a notification to a device of the follower person based on the tracked person adding a scheduled meeting to a schedule of scheduled meetings maintained by a meeting scheduling program.

Numerous potential advantages can be provided by these and further embodiments of the meeting server and related methods disclosed herein. The meeting server through the established tracking operation can enable the follower person to make informed decisions as to which meeting invitations should be accepted based on a desire to overlap or to not-overlap meeting attendances and/or particular meeting time-segments with the tracked person. Furthermore, the follower person can be notified by the meeting server in real-time of any subsequent changes to the tracked person's meeting schedule and/or the present attendance status of the tracked person in any of the scheduled meetings. The meeting server may allow the follower person to dynamically adjust meeting schedules based on such notifications and may responsively facilitate movement of the follower person between meetings.

Other meeting servers and methods according to embodiments will be or become apparent to one with skill in the art upon review of the following drawings and detailed description. It is intended that all such meeting servers and methods be included within this description, be within the scope of the present disclosure, and be protected by the accompanying claims. Moreover, it is intended that all embodiments disclosed herein can be implemented separately or combined in any way and/or combination.

### BRIEF DESCRIPTION OF THE DRAWINGS

Aspects of the present disclosure are illustrated by way of example and are not limited by the accompanying drawings. In the drawings:

FIG. 1 illustrates a system having a virtual conference meeting server which establishes tracking of a tracked person's scheduled meetings by a follower person in accordance with some embodiments of the present disclosure;

FIG. 2 illustrates the tracked person's calendar of scheduled meetings which includes concurrent meetings opportunities which when selected results in tracking notifications to the follower person in accordance with some embodiments of the present disclosure;

FIG. 3 illustrates an example time sequence to demonstrate the tracked person switching between various of the concurrent meetings in accordance with some embodiments of the present disclosure;

FIG. 4 illustrates the example order in which the follower person switches between a Meeting A, Meeting B, and a break room based on determinations of switching between meetings of the tracked person, in accordance with some embodiments of the present disclosure;

FIG. 5 illustrates example operations by the virtual conference meeting server to notify the device of the follower person of when the tracked person's presence status in any of a plurality of scheduled meetings changes, in accordance with some embodiments of the present disclosure;

FIG. 6 illustrates components that may be included in the virtual conference meeting server and which are configured to operation in accordance with some embodiments of the present disclosure;

FIGS. 7 through 13 illustrate flowcharts of operations which may be performed by the virtual conference meeting server during ongoing scheduled meetings in accordance with some embodiments of the present disclosure; and

FIGS. 14 through 16 illustrate flowcharts of operations which may be performed by the virtual conference meeting server before scheduled meetings in accordance with some embodiments of the present disclosure.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of various present inventive concepts to those skilled in the art. It should also be noted that these embodiments are not mutually exclusive. Components from one embodiment may be tacitly assumed to be present/used in another embodiment.

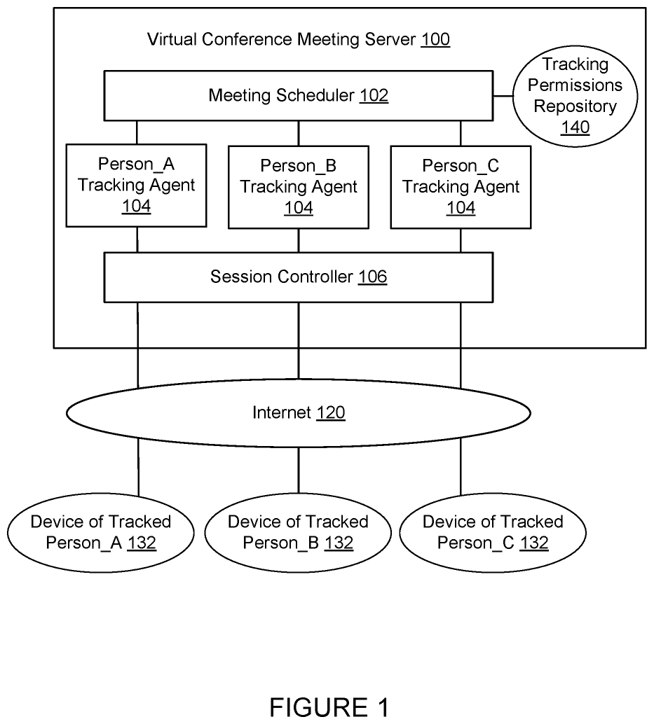

FIG. 1 illustrates a system having a virtual conference meeting server 100 which establishes tracking of a tracked person's scheduled meetings by a follower person in accordance with some embodiments of the present disclosure. Although some embodiments are described herein in the context of operations by a virtual conference meeting server, these and other embodiments are not limited to handling virtual conference meetings but instead can handle any type of meetings including, but not limited to, other types of on-line meetings, in-person attended meetings, etc. Accordingly, the term “virtual conference meeting” can be replaced with the term “meeting” throughout to reflect the breadth of these embodiments.

The virtual conference meeting server 100 can electronically manage meeting schedules for people and enable persons to join a scheduled meeting via a respective device 132. In accordance with various embodiments herein, the meeting scheduler 102 can enable one person to track the meeting schedule of another person and may be notified in real-time when the presence of the other person changes in tracked meeting. The meeting scheduler 102 can establish tracking of a tracked person's scheduled meetings by a follower person, and generate a notification to a device of the follower person based on the tracked person adding a scheduled meeting to a schedule of scheduled meetings.

There can be a myriad of reasons why the follower person wants to follow a tracked person. The follower person may desire to join the same meetings as the tracked person because the follower person would like to assist with discussions or to meet the tracked person during breaks before, between, or after scheduled meetings. For example, if the tracked person will only be available for a short time after a certain meeting, then the follower person can desire to make effective use of the opportunities to talk with the tracked person by adjusting the follower person's schedule to correspond to the tracked person. The follower person may desire to observe discussions or other contributions by the tracked person during the scheduled meeting, such as to compare and discuss experiences from the meeting with the tracked person.

The virtual conference meeting server 100 communicates through one or more networks 120, e.g., public and/or private (Internet) networks, with a plurality of devices of tracked persons 132. The virtual conference meeting server 100 can include a meeting scheduler 102 which may manage a plurality of person tracking agents, illustrated as person_A tracking agent, person_B tracking agent, and person_C tracking agent (also referred to individually as 104 for brevity). The respective tracking agents 104 can, for example, operate to track what meeting invitations a tracked person has accepted and add those meetings to the tracked person's meeting schedule, track the present presence status of the tracked person in the scheduled meetings, notify the follower person of changes in the meeting schedule and attendance status of the tracked person, etc.

These tracking operations can enable the follower person to make informed decisions as to which meeting invitations should be accepted based on a desire to overlap or to not-overlap meeting attendances and/or particular meeting time-segments with the tracked person. Furthermore, the follower person can be notified by the virtual conference meeting server 100 in real-time of any subsequent changes to the tracked person's meeting schedule and/or the present attendance status of the tracked person in any of the scheduled meetings. The virtual conference meeting server 100 may allow the follower person to dynamically adjust meeting schedules based on such notifications and may responsively facilitate movement of the follower person between meetings.

The tracking operation may be selectively allowed based on permission settings defined by a person, such as the tracked person. The virtual conference meeting server 100 can include a tracking permissions repository 140 which is communicatively coupled to the meeting scheduler 102 and used determine if a tracked person has granted tracking permissions to a specified follower person, a defined group of people (e.g., members of a project team, company, etc.), etc. The virtual conference meeting server 100 can include a session controller 106 that can be configured to control routing of meeting content streams to selected ones of the devices 132 based on which meetings the devices 132 are respectively joined. The session controller 106 can perform switching of the device of the follower person from participating in one meeting to participating in another meeting by controlling the routing and combining of the respective content streams for the respective meetings, such as by ceasing streaming a content stream of a departed meeting to the device and initiating streaming of a content stream of a joined meeting to the device. The session controller 106 may use, for example, SIP and/or H.323 protocol to manage the communication sessions. The devices 132 may include, without limitation, a personal computer, a laptop computer, a table computer, a smart phone, wearable device, smart watch, electronic wrist band, a virtual reality (VR) headset, or an augmented reality (AR) headset.

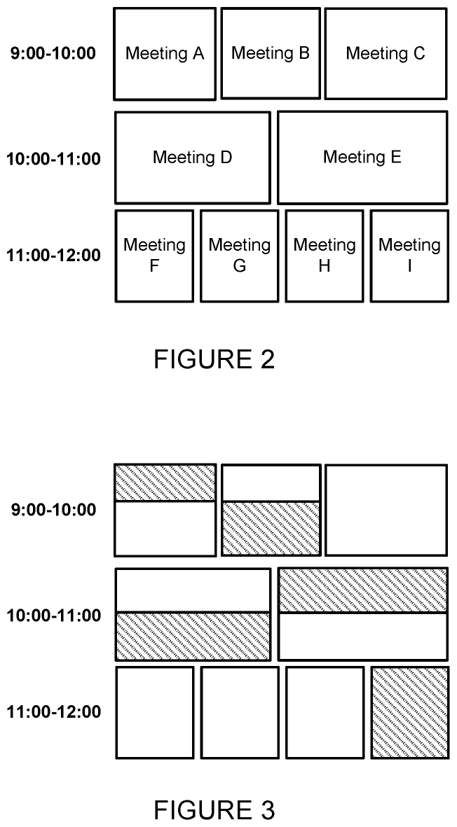

FIG. 2 illustrates the tracked person's calendar of scheduled meetings which includes concurrent meetings opportunities which when selected results in tracking notifications to the follower person in accordance with some embodiments of the present disclosure. In this example, a follower person desires to track the meeting schedule and presence status in any of the scheduled meetings of the tracked person, i.e., is the tracked person presently joined-in a particular meeting. Such tracking would be difficult or not possible if the follower person were provided only the tracked person's calendar of scheduled meetings and were to attempt to determine whether the tracked person has subsequently changed the meeting schedule, attempt to manually track which of the concurrent meetings the tracked person is in at any moment, or attempt to predicting which of the concurrent meetings the tracked person will be in the future. Furthermore, tracking more than one person would be even more difficult.

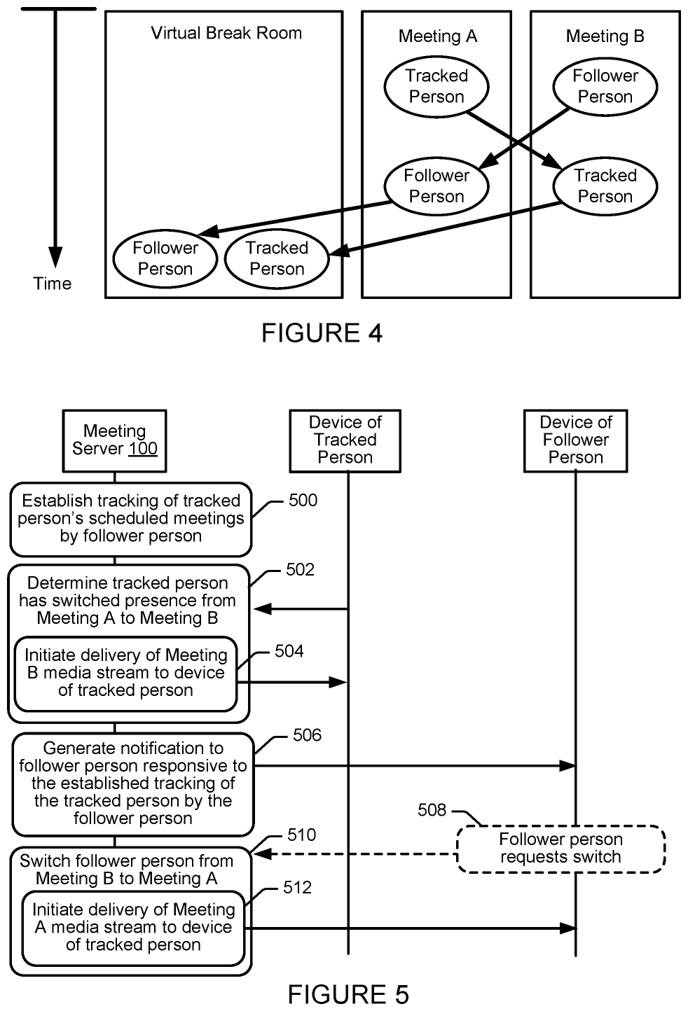

FIG. 3 illustrates an example time sequence to demonstrate the tracked person switching between various of the concurrent meetings in accordance with some embodiments of the present disclosure. The tracked person may switch between various of the concurrent meetings for reasons possibly unpredictable and unknown to the follower person, making attempts by the follower person to manually monitor the tracked person's availability or activity a time consuming and perhaps impossible task. Even if the follower person had access to a predetermined sequence of switches between scheduled meetings of the tracked person, the tracked person's actual schedule may change in real-time because of factors such as scheduled meetings or meeting segments of scheduled meetings running longer or shorter than expected or new impromptu meetings being added during the scheduled meetings.

Presently, there is no detailed search function in meeting scheduling servers to see in which virtual meeting a specific person is present or if the person is not present in a meeting at the moment.

It is difficult or not possible for one person to know when it is suitable to contact another person having a busy meetings schedule. Although normal practice is to attempt to not disturb the other person during the meetings, this may not be possible with existing technology where only the planned schedule for a meeting is shown and not in any way updated in real-time. Meetings can finish earlier than planned or continue longer than planned, so it is hard to know when it is suitable to contact a meeting participant. Also a person may choose to join a meeting sometime after its scheduled start (e.g., because only a later section is relevant, or similarly may choose to leave a meeting earlier than the scheduled end).

In various embodiments of the present disclosure, a follower person can search for a participant (tracked person) in a virtual meeting or in-person meeting and see the tracked person's status, such as which meeting the tracked person is presently attending or planning to attend if the tracked person has granted associated tracking privileges, e.g., made the meeting schedule viewable by the follower person. Some embodiments include a live view in the calendar so that it is clearly shown if a meeting session has ended early or is still ongoing. In some embodiments, if a follower person wishes to talk to a tracked person, the virtual conference meeting server 100 may operate so the follower person can be alerted when the tracked person joins a virtual break room or when a meeting the tracked person attends ends, such as when the meeting ends earlier or later than expected or scheduled. In some embodiments, the virtual conference meeting server 100 may operate so the follower person can see a list of which tracked persons are in a certain meeting without having to join the meeting, such as by hovering a computer cursor over or selecting a displayed indicia corresponding to the meeting.

Numerous potential advantages may be provided by these and further operations of the virtual conference meeting server 100 which are disclosed herein. The virtual conference meeting server 100 may provide a live-view in a calendar program so the follower person can see within which virtual meeting a tracked person is present, present status of various meetings, and which meetings the tracked person is presently scheduled to attend are ongoing. Additionally, the follower person can search for the tracked person and obtain information about which scheduled meetings the tracked person is planning to attend and if that tracked person is currently present in a meeting having scheduled sub-meetings and, if so, determine presence in which sub-meeting. Additionally, the follower person can establish a following operation for a tracked person to receive a notification when the tracked person wants to talk or leaves a meeting or when the meeting the tracked person is in finishes, even if the meeting ends earlier or later than planned. In this way, the follower person can contact the tracked person at a time that is convenient for both people.

The virtual conference meeting server 100 may perform various operations before a scheduled meeting or during an ongoing scheduled meeting.

Example operations that may be performed during ongoing scheduled meetings will now be discussed.

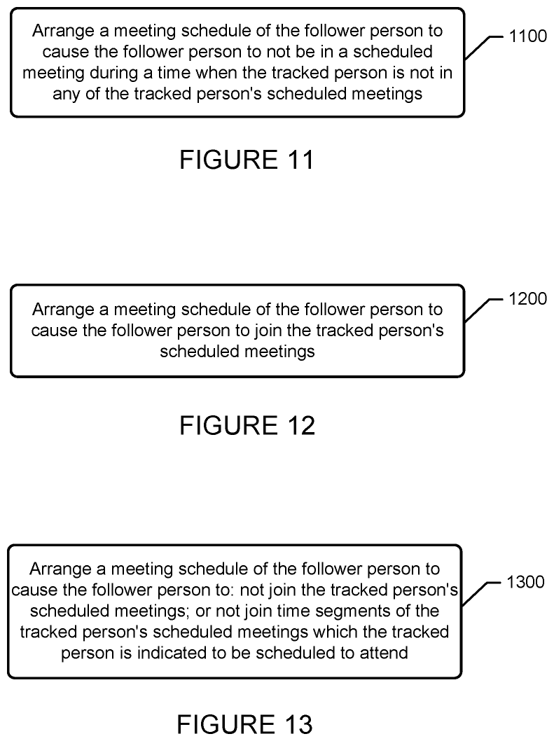

FIGS. 7 through 13 illustrate flowcharts of operations which may be performed by the virtual conference meeting server 100 during ongoing scheduled meetings in accordance with some embodiments of the present disclosure.

Referring to FIGS. 1 and 7, various embodiments of the present disclosure are directed to a virtual conference meeting server 100 which operates to establish 700 tracking of a tracked person's scheduled meetings by a follower person. The virtual conference meeting server 100 also operates to generate 702 a notification to a device of the follower person based on the tracked person adding a scheduled meeting to a schedule of scheduled meetings maintained by a meeting scheduling program.

Referring to FIG. 8, in some embodiments, the operations further include generating 800 a list of the tracked person's scheduled meetings responsive to a request from the device of the follower person. The operations also include communicating 802 the list of the tracked person's scheduled meetings to the device of the follower person.

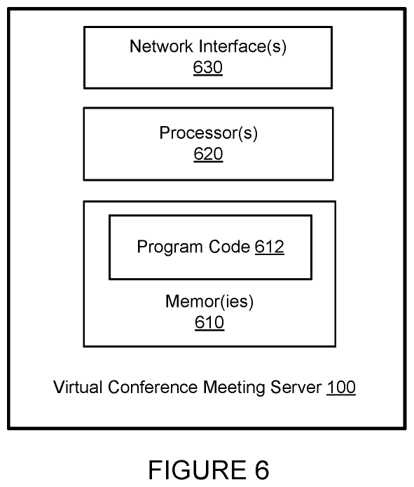

FIG. 4 illustrates the example order in which the follower person switches between a Meeting A, a Meeting B, and a break room based on considering notifications generated by the virtual conference meeting server 100 determining the tracked person has switched between meetings, in accordance with some embodiments of the present disclosure. In the example illustrated in FIG. 4, the tracked person has two scheduled meetings, Meeting A and Meeting B. If the tracked person is not attending a meeting at any time, represented by the tracked person being in the virtual break room, then the tracked person is available to talk with the follower person. In this example, the follower person has been designated by the tracked person as having permission to track the tracked person, i.e. in the tracking permissions repository 140. The follower person desires to not overlap the meeting schedule of the tracked person. Accordingly, the follower person has indicated to the virtual conference server 100 to notify the follower person of the meeting the tracked person is not in while the tracked person is in one of the two concurrent meetings, so the follower person can get information from the meeting the tracked person is not attending. Additionally, the follower person has also indicated to the virtual conference server 100 that the follower wishes to be notified when the tracked person becomes available so the follower may talk to the tracked person as soon as possible. These operations enable the follower person to track the tracked person while attending other meetings.

Referring to FIG. 4, first, the tracked person joins Meeting A based on a schedule indication for which of the plurality of meetings the tracked person plans to attend first. The tracked person has made a schedule indication that the tracked person planned to only attend Meeting A before the start of the scheduled meeting. Therefore, the virtual conference meeting server 100 generates a notification to the device of the follower person indicating the tracked person's plan to attend Meeting A and for the follower person to attend Meeting B.

In this example, upon the start of both Meeting A and Meeting B, the tracked person joins Meeting A, and responsively the follower person joins Meeting B. The virtual conference meeting server 100 tracks a presence status of the tracked person, which indicates the tracked person is in Meeting A. Then, the tracked person breaks from the schedule indication and exits Meeting A and immediately joins Meeting B. The virtual conference meeting server 100 determines the presence status of the tracked person in Meeting A has changed and that the tracked person has switched to Meeting B. Responsively, the virtual conference meeting server 100 generates a notification to the device of the follower person based on the tracked person switching to Meeting B and suggests the follower person switches to Meeting A. Therefore, the follower person exits Meeting B and immediately joins Meeting A. The virtual conference meeting server 100 may facilitate automated switching of the follower person from Meeting B to Meeting A by controlling the session controller 106 to switch which meeting media streams are routed to the device of the follower person (i.e., cease routing Meeting B media stream and being routing Meeting A media stream to device of follower person).

Then in this example, tracked person exits Meeting B and does not join another meeting. Therefore, the tracked person is designated as in the virtual break room during which the tracked person is known to being available to be contacted by other persons. The virtual conference meeting server 100 determines the presence status of the tracked person in Meeting B has changed and that the tracked person has switched to the virtual break room. Responsively, the virtual conference meeting server 100 generates a notification to the device of the follower person based on the tracked person switching to the virtual break room and suggests the follower person switches to the virtual break room because the tracked person is available. Responsively, the follower person exits Meeting A and automatically joins the virtual break room. Then the follower person can immediately contact the tracked person just as the follower person indicated to the virtual conference meeting server 100.

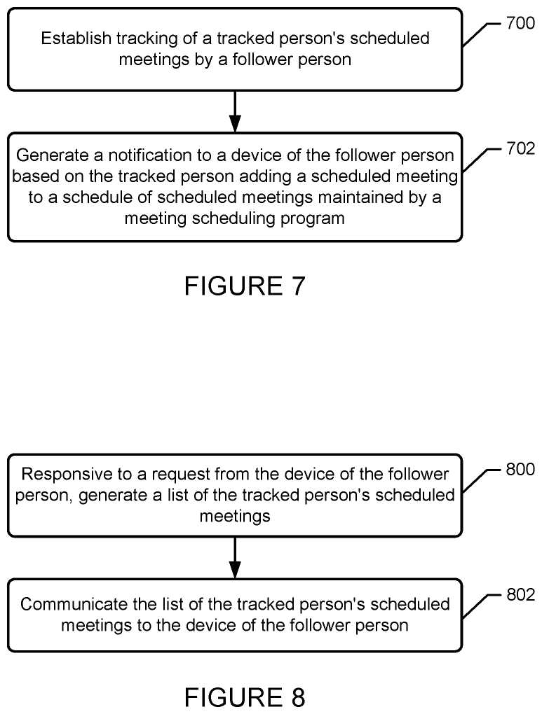

FIG. 5 illustrates example operations by the virtual conference meeting server 100 to notify the device of the follower person of when the tracked person's presence status in any of a plurality of scheduled meetings changes, in accordance with some embodiments of the present disclosure. The virtual conference meeting server 100 establishes 500 the tracking of the tracked person's scheduled meetings by the follower person. The virtual conference meeting server 100 determines 502 the tracked person has switched presence from Meeting A to Meeting B. The virtual conference meeting server 100 initiates 504 delivery of Meeting B media stream to the device of tracked person 132. The virtual conference meeting server 100 generates 506 a notification to the follower person responsive to the established tracking of the tracked person by the follower person. The follower person may request 508 a switch from Meeting B to Meeting A based on the notification from the virtual conference meeting server 100. The virtual conference meeting server 100 switches 510 the follower person from Meeting B to Meeting A either based on the request 508 or the satisfaction of a defined rule. Responsively, the virtual conference meeting server 100 initiates delivery of Meeting A media stream to the device of follower person.

Tracking may also be performed by the virtual meeting conference server 100 on more than one tracked person.

In one example of various embodiments of the present disclosure, the virtual conference meeting server 100 may operate to get a list of all participants in the sub meetings in real-time when the follower person hovers a computer cursor over a displayed indicia meeting schedule or selects the displayed indicia of the meeting schedule. This real-time view in the follower person's calendar also shows which meetings are ongoing, and this display can be updated in real-time so that it shows when meetings have finished earlier than scheduled or are ongoing past the scheduled finishing time.

The follower person may also be able to click on the side of the tracked person's name to see if the tracked person is present in a large meeting having sub-meetings and, if so, further see in which sub-meeting the follower person is present.

In some embodiments, the virtual conference meeting server 100 may operate to provide the follower person with a real-time update indicating as to which meetings and/or sub-meetings a group of tracked person are attending.

The follower person can notify the virtual conference meeting server 100 that the follower person wants to follow the activities of a tracked person and specify how (e.g., phone application notification, receive text message, receive phone call, etc.) the follower person wants to be notified when the tracked person enters and/or leaves one meeting and maybe joins another meeting or the break room.

Referring to FIG. 9, in some embodiments, the operations further include tracking 900 a presence status of the tracked person in one of the scheduled meetings. The operations also include generating 902 a notification to the device of the follower person responsive to determining that the presence status of the tracked person has changed.

The presence of a tracked person may also be determined based on the virtual presence of a tracked person in a meeting that is virtual.

In some of embodiments, the operation to track the presence status of the tracked person includes determining that the presence status of the tracked person for the one of the scheduled meetings is virtually present responsive to the tracked person electronically joining to receive a media stream for the one of the scheduled meetings.

In some of embodiments, the operation to track the presence status of the tracked person includes generating a list of participants in the one of the scheduled meetings responsive to receiving an indication from the device of the follower person indicating that the follower person has selected a displayed indicia relating to the one of the scheduled meetings. The operation also includes providing the list of participants to the device of the follower person. The operation also includes receiving a request from the device of the follower person indicating which one or more participants among the list are to be followed. The operation also includes establishing tracking by the follower person of the presence status in the one of the scheduled meetings of the one or more participants indicated in the request.

The tracked person may have more than one device. For instance, some meeting participants don't know how to or have the ability to attend scheduled meetings in a VR environment with a VR headset, so the scheduler may book a Teams meeting at the same time for those participants. For example, previously, when Person A didn't find Person B in the VR meeting, Person A had to remove his or her VR headset and join in the non-VR meeting with a separate device to check if Person B was in that meeting. Person B may arrive in the VR meeting after Person A exited, which may result in Person A missing Person B in the VR meeting and not finding Person B in the non-VR meeting. So it would be advantageous for Person A to be able to track Person B via different devices at the same time, such as a VR headset, computer, or mobile device, to show which device Person B is using or being active, besides which meeting Person B is attending. Persons A and B may be able to communicate across the different devices, such as via text messaging, voice calls, etc. In accordance with some embodiments, the ability for Person A to contact Person B and, vice versa, can be simplified by use of the tracking information indicating which device(s) are currently being used by which tracked persons.

The presence of a tracked person may also be determined based on the physical presence of a tracked person in a meeting that is setup to be attended at least partially in-person.

In some of embodiments, the operation to track the presence status of the tracked person includes determining that the presence status of the tracked person in the one of the scheduled meetings is physically present responsive to receiving information indicating that a device of the tracked person 132 is detecting RF signaling directly from at least one device having a known association with at least one other person who is scheduled to attend the one of the scheduled meetings.

In some embodiments, the operation to track the presence status of the tracked person includes determining that the presence status of the tracked person in the one of the scheduled meetings is physically present based on using GPS via the tracked person's location on the tracked person's mobile device, smart watch, or similar which matches the location of the scheduled meeting. Alternatively, the mobile device of the tracked person may indicate the tracked person is physically present by detecting the mobile device of the tracked person connected to a Wi-Fi identifier known as being at the location of the scheduled meeting.

In some of embodiments, the operation to track the presence status of the tracked person includes determine that the presence status of the tracked person in the one of the scheduled meetings is physically present responsive to at least one of two determinations. The first determination includes determining that a device of the tracked person 132 is within a first threshold distance of a defined location for the scheduled meeting. The second determination includes determining that the device of the tracked person 132 is within a second threshold distance of a defined location of at least one device having a known association with at least one other person who is scheduled to attend the one of the scheduled meetings.

Some embodiments include a live view in the calendar to clearly shown if a meeting session has ended early or is still ongoing.

Referring to FIG. 10, in some embodiments, the operations further include updating 1000 the presence status of the tracked person for the one of the scheduled meetings to indicate not present responsive to a determination that the one of the scheduled meetings has ended. The operations also include generating 1002 a notification to the device of the follower person responsive to determining that the presence status of the tracked person has changed.

The follower person may also indicate at least one area of interest of the follower person. In some embodiments, the virtual conference meeting server 100 may operate to follow a tracked person based on indicated interest of the follower person.

In some interests, the operation to establish tracking of the tracked person's scheduled meetings by the follower person includes establishing tracking of the tracked person's scheduled meetings based on a determination that the tracked person satisfies a relevance rule relative to an indicated interest of the follower person.

Adjusting the schedule of the follower person may be performed based on the tracked person's actions. For example, the tracked person joining a meeting, being present in a meeting, participating in the meeting as a presenter, or leaving the meeting.

Referring to FIG. 11, in some embodiments, the operations further include arranging 1100 a meeting schedule of the follower person to cause the follower person to not be in a scheduled meeting during a time when the tracked person is not in any of the tracked person's scheduled meetings.

Referring to FIG. 12, in some embodiments, the operations further include arranging 1200 a meeting schedule of the follower person to cause the follower person to join the tracked person's scheduled meetings.

Referring to FIG. 2, in some embodiments, if the follower person has decided to switch from Meeting A to Meeting B in response to the generation 700 of the notification, the session controller 106 may be controlled to move the device of the follower person between scheduled meetings to cease the device receiving the content stream of the Meeting A and begin the device receiving the content stream of the Meeting B.

In some situations, the follower person is interested in avoiding attending a meeting or a time segment of the meeting that the tracked person attends for a myriad of reasons, such as, the follower person wanting to fill in for the tracked person once the tracked person leaves the meeting, or to allow the follower person to cover another meeting topic than the tracked person so that more meetings topics are covered. The attendance of the tracked person can be clearly displayed in the meeting schedule of the follower person when the tracked person chooses which meeting or segment(s) of the meeting to attend. Then the follower person can attend meetings or segments of the meeting that the tracked person does not intend to attend. The tracked person can also publish information (e.g., to colleagues, etc.) or otherwise define tracking permissions in the repository 140 indicating which meetings or time segments of meetings the tracked person is scheduled to attend.

Referring to FIGS. 1 and 13, in some embodiments, the operations further include arranging a meeting schedule of the follower person to cause the follower person to not join the tracked person's scheduled meetings or not join time segments of the tracked person's scheduled meetings which the tracked person is indicated to be scheduled to attend.

Example operations that may be performed before scheduled meetings will now be discussed.

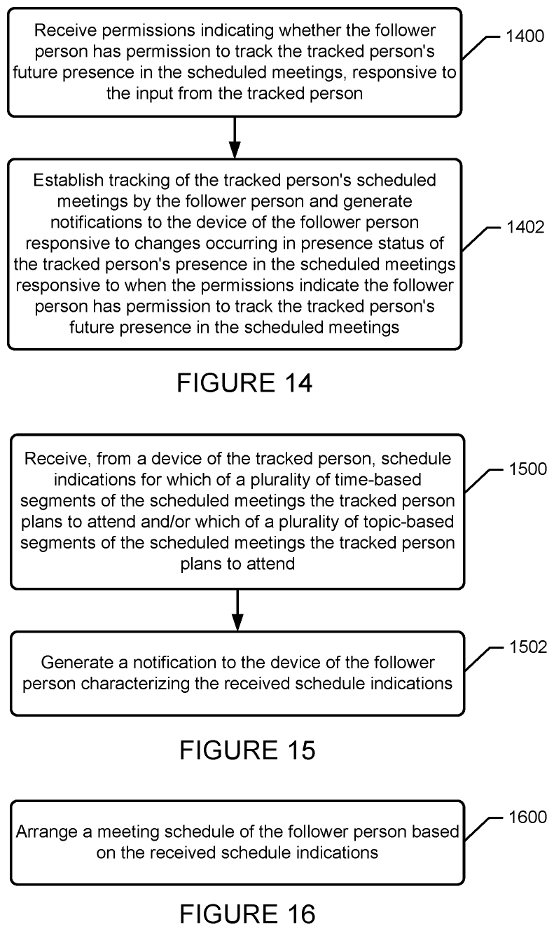

FIGS. 14 and 16 illustrate flowcharts of operations which may be performed by the virtual conference meeting server 100 before scheduled meetings in accordance with some embodiments of the present disclosure.

Referring to FIGS. 1 and 15, in some embodiments, the operations further include receiving 1500, from a device of the tracked person 132, schedule indications for which of a plurality of time-based segments of the scheduled meetings the tracked person plans to attend and/or which of a plurality of topic-based segments of the scheduled meetings the tracked person plans to attend. The operations also include generating 1502 a notification to the device of the follower person characterizing the received schedule indications.

Referring to FIG. 16, in some of the proceeding embodiment, the operations also further include arranging 1600 a meeting schedule of the follower person based on the received schedule indications.

For example, the follower person may plan to attend or have registered to a large meeting with sub meetings, for instance a large conference or standardization meeting with many participants and many sub sessions to discuss different topics. The follower person would like to know if a certain person (e.g., the tracked person) has registered for the meeting and also which sub meetings that tracked person plans to attend.

In this example, the virtual conference meeting server 100 may operate to search for a name without knowing if that tracked person has registered for the meeting or not. Furthermore, the operations may generate a list of tracked persons who have registered for a meeting and enable a follower person to select persons in the list for real-time notifications to be generated.

As stated above, the virtual conference meeting server 100 can access the tracking permissions repository 140 to determine if a specified follower person has needed permissions to allow tracking of a specified tracked person. The tracking permissions repository 140 contains the privacy preferences of potential tracked persons. A tracked person may indicate the preference of not allowing others to follow their activity or allow others satisfying a characteristic or rule to follow the tracked person. The characteristic or rule may include at least one of all other people, people in the tracked person's organization, and a list of specified people defined by the tracked person, etc.

In some embodiments, an administrator of the tracked person or another participant may indicate the preference of not allowing others to follow their activity or allow others satisfying a characteristic or rule to follow the tracked person.

In some embodiments, if a follower person does not have permissions to allow tracking of a specified tracked person, the follower person may send a request to the tracked person for the permissions to allow tracking.

In some embodiments, the operation to establish tracking of the tracked person's scheduled meetings by the follower person includes receiving permissions indicating whether the follower person has permission to track the tracked person's scheduled meetings responsive to input from the tracked person. The operation to establish tracking of the tracked person's scheduled meetings also includes establishing tracking of the tracked person's scheduled meetings by the follower person responsive to when the permissions indicate the follower person has permission to track the tracked person's scheduled meetings. The operation to establish tracking of the tracked person's scheduled meetings also includes preventing establishment of tracking of the tracked person's scheduled meetings by the follower person responsive to when the permissions do not indicate the follower person has permission to track the tracked person's scheduled meetings.

Referring to FIG. 14, in some of the proceeding embodiments, the operations further include receiving 1400 permissions indicating whether the follower person has permission to track the tracked person's future presence in the scheduled meetings, responsive to the input from the tracked person. The operations also include establishing 1402 tracking of the tracked person's scheduled meetings by the follower person and generate notifications to the device of the follower person responsive to changes occurring in presence status of the tracked person's presence in the scheduled meetings responsive to when the permissions indicate the follower person has permission to track the tracked person's future presence in the scheduled meetings.

In some embodiments, prior to a scheduled meeting or meetings, the tracked person can identify which topics in a scheduled meeting or meeting segments the tracked person plans to be present for during the meeting and/or which topics in the scheduled meeting or meeting segments the tracked person does not plan to be present during. The planned movements of that tracked person into a meeting, out of the meeting, and/or between meetings can then be further tracked by the follower person.

In some embodiments, the follower person can request to be invited to any scheduled meetings that the tracked person is invited to which satisfies a defined rule, such as a scheduled meeting having has certain defined characteristics. Similarly, in another embodiment, the tracked person could define one or more other people who should be invited to any meeting the tracked person is invited to when that meeting satisfies a defined rule, such as a scheduled meeting having has certain defined characteristics. In some other embodiments, duplicative attendance may not be needed, so the follower person may be disinvited from a scheduled meeting they were scheduled to attend, or the follower person is informed so as to avoid duplicative attendance at the same meeting as the tracked person.

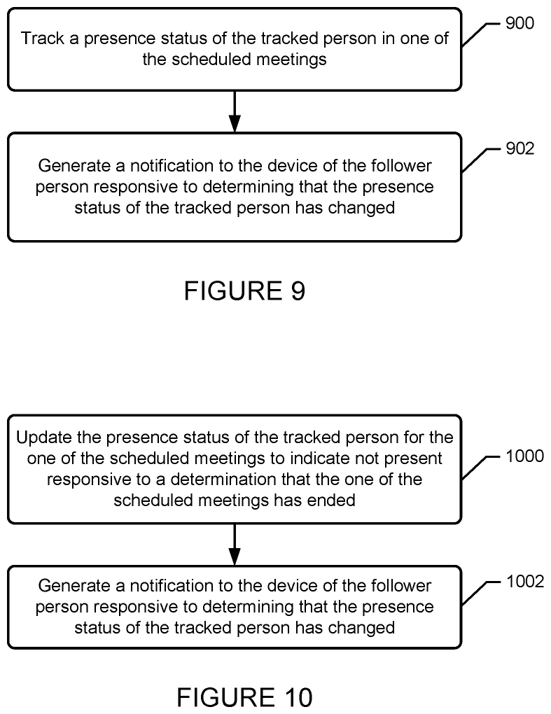

FIG. 6 illustrates hardware circuit components that may be included in the virtual conference meeting server 100 of FIG. 1 which are configured to operation in accordance with some embodiments of the present disclosure. Referring to FIG. 6, the virtual conference meeting server 100 can include at least one network interface 630 (network for brevity), at least one processor 620 (processor for brevity), and at least one memory 610 (memory for brevity) storing program code 612. The processor 620 may include one or more data processing circuits, such as a general purpose and/or special purpose processor (e.g., microprocessor and/or digital signal processor) that may be collocated or distributed across one or more networks. The processor 620 is configured to execute the program code 612 to perform operations according to one or more embodiments disclosed herein for a virtual conference meeting server.

Further Definitions and Embodiments:

In the above description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.,”, which derives from the Latin phrase “exempli gratia,” may be used to introduce or specify a general example or examples of a previously mentioned item, and is not intended to be limiting of such item. The common abbreviation “i.e.,”, which derives from the Latin phrase “id Est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the appended examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the following examples of embodiments and their equivalents, and shall not be restricted or limited by the foregoing detailed description.

1. A meeting server comprising:
at least one processor; and
at least one memory storing program code executable by at least one processor to perform operations comprising to:
establish tracking of a tracked person's scheduled meetings by a follower person; and
generate a notification to a device of the follower person based on the tracked person adding a scheduled meeting to a schedule of scheduled meetings maintained by a meeting scheduling program.

2. The meeting server of claim 1, wherein the operations further comprise:
responsive to a request from the device of the follower person, generate a list of the tracked person's scheduled meetings; and
communicate the list of the tracked person's scheduled meetings to the device of the follower person.

3. The meeting server of claim 1, wherein the operations further comprise:
track a presence status of the tracked person in one of the scheduled meetings; and
generate a notification to the device of the follower person responsive to determining that the presence status of the tracked person has changed.

4. The meeting server of claim 3, wherein the operation to track the presence status of the tracked person in the one of the scheduled meetings further comprises:
determine that the presence status of the tracked person for the one of the scheduled meetings is virtually present responsive to the tracked person electronically joining to receive a media stream for the one of the scheduled meetings.

5. The meeting server of claim 3, wherein the operation to track the presence status of the tracked person in the one of the scheduled meetings further comprises:
generate a list of participants in the one of the scheduled meetings responsive to receiving an indication from the device of the follower person indicating that the follower person has selected a displayed indicia relating to the one of the scheduled meetings;
provide the list of participants to the device of the follower person;
receive a request from the device of the follower person indicating which one or more participants among the list are to be followed; and
establish tracking by the follower person of the presence status in the one of the scheduled meetings of the one or more participants indicated in the request.

6. The meeting server of claim 3, wherein the operation to track the presence status of the tracked person in the one of the scheduled meetings further comprises:
determine that the presence status of the tracked person in the one of the scheduled meetings is physically present responsive to receiving information indicating that a device of the tracked person is detecting RF signalling directly from at least one device having a known association with at least one other person who is scheduled to attend the one of the scheduled meetings.

7. The meeting server of claim 3, wherein the operation to track the presence status of the tracked person in the one of the scheduled meetings further comprises:
determine that the presence status of the tracked person in the one of the scheduled meetings is physically present responsive to at least one of:
determining that a device of the tracked person is within a first threshold distance of a defined location for the scheduled meeting; and
determining that the device of the tracked person is within a second threshold distance of a defined location of at least one device having a known association with at least one other person who is scheduled to attend the one of the scheduled meetings.

8. The meeting server of claim 3, wherein the operations further comprise:
update the presence status of the tracked person for the one of the scheduled meetings to indicate not present responsive to a determination that the one of the scheduled meetings has ended;
generate a notification to the device of the follower person responsive to determining that the presence status of the tracked person has changed.

9. The meeting server of claim 1, wherein the operation to establish tracking of the tracked person's scheduled meetings by the follower person further comprise:
establish tracking of the tracked person's scheduled meetings based on a determination that the tracked person satisfies a relevance rule relative to an indicated interest of the follower person.

10. The meeting server of claim 1, wherein the operations further comprise:
arrange a meeting schedule of the follower person to cause the follower person to not be in a scheduled meeting during a time when the tracked person is not in any of the tracked person's scheduled meetings.

11. The meeting server of claim 1, wherein the operations further comprise:
arrange a meeting schedule of the follower person to cause the follower person to join the tracked person's scheduled meetings.

12. The meeting server of claim 1, wherein the operations further comprise:
arrange a meeting schedule of the follower person to cause the follower person to:
not join the tracked person's scheduled meetings; or
not join time segments of the tracked person's scheduled meetings which the tracked person is indicated to be scheduled to attend.

13. The meeting server of claim 1, wherein the operation to establish tracking of the tracked person's scheduled meetings by the follower person further comprises to:
responsive to input from the tracked person, receive permissions indicating whether the follower person has permission to track the tracked person's scheduled meetings;
responsive to when the permissions indicate the follower person has permission to track the tracked person's scheduled meetings, establish tracking of the tracked person's scheduled meetings by the follower person; and
responsive to when the permissions do not indicate the follower person has permission to track the tracked person's scheduled meetings, prevent establishment of tracking of the tracked person's scheduled meetings by the follower person.

14. The meeting server of claim 13, wherein the operations further comprise:
receive permissions indicating whether the follower person has permission to track the tracked person's future presence in the scheduled meetings, responsive to the input from the tracked person; and
responsive to when the permissions indicate the follower person has permission to track the tracked person's future presence in the scheduled meetings, establish tracking of the tracked person's scheduled meetings by the follower person and generate notifications to the device of the follower person responsive to changes occurring in presence status of the tracked person's presence in the scheduled meetings.

15. The meeting server of claim 1, wherein the operations further comprise:
receiving, from a device of the tracked person, schedule indications for which of a plurality of time-based segments of the scheduled meetings the tracked person plans to attend and/or which of a plurality of topic-based segments of the scheduled meetings the tracked person plans to attend; and
generating a notification to the device of the follower person characterizing the received schedule indications.

16. The meeting server of claim 15, wherein the operations further comprise:
arrange a meeting schedule of the follower person based on the received schedule indications.

17. A method by a meeting server, the method comprising:
establishing tracking of a tracked person's scheduled meetings by a follower person; and
generating a notification to a device of the follower person based on the tracked person adding a scheduled meeting to a schedule of scheduled meetings maintained by a meeting scheduling program.

18. The method of claim 17, further comprising:
tracking a presence status of the tracked person in one of the scheduled meetings; and
generating a notification to the device of the follower person responsive to determining that the presence status of the tracked person has changed.

19. The method of claim 17, wherein the establishing tracking of the tracked person's scheduled meetings by the follower person, comprises:
responsive to input from the tracked person, receiving permissions indicating whether the follower person has permission to track the tracked person's scheduled meetings;
responsive to when the permissions indicate the follower person has permission to track the tracked person's scheduled meetings, establishing tracking of the tracked person's scheduled meetings by the follower person; and
responsive to when the permissions do not indicate the follower person has permission to track the tracked person's scheduled meetings, preventing establishment of tracking of the tracked person's scheduled meetings by the follower person.

20. The method of claim 17, further comprising:
receiving permissions indicating whether the follower person has permission to track the tracked person's future presence in the scheduled meetings, responsive to the input from the tracked person; and
responsive to when the permissions indicate the follower person has permission to track the tracked person's future presence in the scheduled meetings, establishing tracking of the tracked person's scheduled meetings by the follower person and generating notifications to the device of the follower person responsive to changes occurring in presence status of the tracked person's presence in the scheduled meetings.

21. The method of claim 17, further comprising:
receiving, from a device of the tracked person, schedule indications for which of a plurality of time-based segments of the scheduled meetings the tracked person plans to attend and/or which of a plurality of topic-based segments of the scheduled meetings the tracked person plans to attend; and
generating a notification to the device of the follower person characterizing the received schedule indications.

22. The method of claim 21, further comprising:
arranging a meeting schedule of the follower person based on the received schedule indications.
